(19) United States
(12) Patent Application Publication
(10) Pub. No.: US 2022/0162098 A1
(43) Pub. Date: May 26, 2022

(54) AN OZONE GENERATOR APPARATUS WITH FASTENING AND GROUNDING SYSTEM

(71) Applicant: Primozone Production AB, Löddeköpinge (SE)

(72) Inventor: Fredrik Stoltz, Löddeköpinge (SE)

(21) Appl. No.: 17/440,434

(22) PCT Filed: Apr. 3, 2020
(86) PCT No.: PCT/EP2020/059610

§ 371 Date: Sep. 17, 2021

(30) Foreign Application Priority Data
Apr. 5, 2019 (EP) 19167532.1

(51) Int. Cl. C02F 1/78; F16B 5/12; H01R 4/26; H01R 43/00; C01B 13/11

(52) U.S. Cl. CPC C02F 1/78; F16B 5/121; H01R 4/26; F16B 2001/0064; C01B 13/11; C02F 2201/782; H01R 43/00

(57) ABSTRACT

The present invention relates to an ozone generator apparatus (5) comprising a fastening and grounding system (14) for fastening and providing earth connection between the ozone generator apparatus (5) and a mounting plate (13), an ozone generator apparatus mounting kit, a method of fastening an ozone generator apparatus (5), a method of grounding an ozone generator apparatus (5) and a method of providing heat exchange between an ozone generator apparatus (5) and a mounting plate (13).

### FIELD OF THE INVENTION

The present invention relates to a fastening and grounding system for fastening and providing earth connection between an ozone generator apparatus and a mounting plate, an ozone generator apparatus comprising the fastening and grounding system, an ozone generator apparatus mounting kit, a method of fastening an ozone generator apparatus, a method of grounding an ozone generator apparatus and a method of providing heat exchange between an ozone generator apparatus and a mounting plate.

### BACKGROUND OF THE INVENTION

Successful ozone water treatment depends on the ability of securing optimal installation, mounting, grounding and cooling of ozone generators.

Correct removal of heavy metal from contaminated ground water, appropriate removal of colloidal solids, dissolved organic compounds and transformation of nitrite into nitrate in aquaculture systems and efficient solutions to municipal ozone water treatment issues depend on the ability of securing the required level of ozone in the water at all times and thus the ability of operating, removing and substituting ozone generators that do not work efficiently.

Ozone generators are generally mounted together thought the use of metal mounting plates.

Mounting plates may be deliver with protecting insulating layers or exposed to air may form an insulating oxide layer. This does not allow for optimal electrical contact between the ozone generators and the mounting plates.

Currently to achieve good grounding, ozone generators are screwed to mounting plates so as to ensure that the insulation oxide layer is removed and direct electrical contact between the ozone generator and the mounting plates is provided. However, the electrical contact between the ozone generator and the mounting plate obtained through the screw is not optimal.

Furthermore, this mounting method has the drawback that removal of ozone generators from the mounting plate for maintenance purposes is laborious and time consuming.

Moreover, the use of screw mounting causes bending of the external housing of the ozone generators and thus in turn providing poor contact between the mounting plate surface and the external surface of the housing. This bending produces poor heat exchange between the two surfaces and thus reduction of the efficiency of ozone generation.

Hence, an improved method and system for fastening and grounding an ozone generator to a mounting plate, would be advantageous, and in particular a more efficient and reliable method and system for fastening and grounding an ozone generator to a mounting plate which furthermore ensure an optimal heat exchange, would be advantageous.

### OBJECT OF THE INVENTION

An object of the present invention is to provide an efficient fastening and grounding system for fastening and providing earth connection between an ozone generator apparatus and a mounting plate.

A further object of the present invention is to provide an ozone generator apparatus and an ozone generator apparatus mounting kit comprising a fastening and grounding system for fastening and grounding the ozone generator apparatus, which eases the mounting and dismounting of the apparatus for periodic maintenance.

Another object of the present invention is to provide an efficient and effective method of fastening an ozone generator apparatus, which eases the mounting and dismounting of the apparatus for periodic maintenance.

An object of the present invention may be seen as the provision of an improved method of grounding an ozone generator apparatus, ensuring optimal grounding while fastening.

An even further object of the invention may be seen as the provision of a method of providing improved heat exchange between an ozone generator apparatus and a mounting plate.

An object of the present invention may also be seen as to provide an alternative to the prior art.

In particular, it may be seen as an object of the present invention to provide an efficient grounding and fastening system for providing earth connection and fastening between an ozone generator apparatus and a mounting plate and a method for grounding and fastening an ozone generator apparatus that solves the above mentioned problems of the prior art by providing both functions in a single system and a single step.

### SUMMARY OF THE INVENTION

Thus, the above described object and several other objects are intended to be obtained in a first aspect of the invention by providing a fastening and grounding system for fastening and providing earth connection between an ozone generator apparatus and a mounting plate, the fastening and grounding system comprising:

one or more holding or retainer elements adapted or configured to hold at least part of a mounting plate; and at least one moveable plate element.

The at least one movable plate element is a plate that can be moved in one or more direction over the mounting plate.

The fastening and grounding system of the invention provides an efficient and fast way of fastening and providing earth connection simultaneously by single movement or action on the at least one moveable plate element.

The mounting plate is generally an elongated metal plate that is used to fasten one or more ozone generator apparatus together.

The mounting plate is generally made of metal such as aluminium.

Aluminium can easily be oxidized when exposed to air, thus forming an isolating layer of aluminium oxide.

To ensure good grounding, currently ozone generators are screwed to mounting plates so as to ensure that the isolation layer of aluminium oxide is removed and direct electrical contact between the ozone generator and the mounting plate is established.

However, this method has the drawback that removal of ozone generator apparatus for maintenance purposes from the mounting plate is laborious and time consuming.

The use of the one or more holding or retainer elements adapted or configured to hold at least part of a mounting plate in combination with the at least one moveable element overcome the drawback of the use of the screw and provide an efficient grounding and fastening system.

The one or more holding or retainer elements adapted or configured to hold at least part of a mounting plate may be any piece of metal or plastic attached to the housing of the ozone generator apparatus having the function of supporting the mounting plate.

For example, the one or more holding or retainer elements adapted or configured to hold at least part of a mounting plate may be one or more brackets.

In a preferred embodiment, the at least one movable plate element is at least one rotating plate element.

The at least one rotating plate element may be a flat ring, such as a washer type ring, having the function of pushing or easing, such as moving gradually, the mounting plate into the one or more holding or retainer elements, upon rotation. This may be achieved by having portions of the external circumference of the at least one rotating plate element with different diameters.

The at least one pushing or easing element may thus be a radial protrusion on the external surface of the at least one rotating plate element.

In some further embodiments, the at least one rotating plate element has at least one pushing or easing element and one or more scraping portions.

Both functions of ensuring tight fastening and grounding may be comprised in the same plate element.

Upon rotation, the at least one rotating plate element may fasten and scrape the surface of the mounting plate through its scraping portions, thus ensuring fastening and grounding.

In some embodiments, the at least one rotating plate element are a first rotating plate element and a second rotating plate element, wherein the first rotating plate element comprises the at least one pushing or easing element and the second rotating plate element comprises the one or more scraping portions.

Both functions of ensuring tight fastening and grounding may be achieved through the use of two moveable plates.

A first rotating plate element may be a flat ring, such as a washer type ring, having one or more radial protrusions on the external circumference, thus having a ring profile showing portions having different diameters, which will gradually move a mounting plate having a complementary surface into the one or more holding or retainer elements.

In some further embodiments, the at least one pushing element is located at a boundary of the at least one rotating plate element or of the first rotating plate element.

In some other embodiments the at least one pushing element is configured or adapted to ease, i.e. move gradually, upon rotation of the at least one rotating plate element or of the first rotating plate element, at least part of a mounting plate, having a first surface in contact with the ozone generator apparatus, into the one or more holding or retainer elements.

In some embodiments the at least one pushing element comprises a bended edge portion of the boundary of the at least one rotating plate element or of the first rotating plate element.

In some embodiments, the bended edge portion of the boundary of the at least one rotating plate element or of the first rotating plate element is out of plane of the at least one rotating plate element or of the first rotating plate element.

The bended edge portion, upon rotation of the first rotating plate element keeps the mounting plate in place.

The bended edge portion may be complementary to portions on the surface of the mounting plate.

A second rotating element may also be a flat ring having sharp indentations that would gradually scrape an external complementary surface of a mounting plate upon rotation, thus removing the insulating oxide layer and providing good electrical contact.

The one or more scraping portions may thus comprise one or more indentations extending out of plane of the at least one rotating plate element or of the second rotating plate element.

The one or more indentations may have sharp ends.

The number of indentation, the profile of the indentation may be optimized so as to achieve an improved scraping effect.

For example, the indentation may be three or more and have a tilted profile so to improve the scraping effect.

In some embodiments, the one or more scraping portions are adapted or configured to, upon rotation of said at least one rotating plate element or of the second rotating plate element, scrape and at least remove part of an outer layer of a second surface of a mounting plate having a first surface in contact with the ozone generator apparatus.

The second surface of the mounting plate may be opposite to the first surface in contact with the ozone generator apparatus.

In a second aspect, the invention relates to an ozone generator apparatus comprising the fastening and grounding system according to the first aspect of the invention.

Generally, the ozone generator apparatus comprises a metal housing, such as a metal housing comprising aluminium and the fastening and grounding system is located onto an external surface of the metal housing.

The metal housing may be the metal housing of a transformer assembly comprised in the ozone generator apparatus, i.e. the metal housing may be the housing of a transformer assembly or high voltage transformer containing the transformer assembly.

In a third aspect, the invention relates to an ozone generator apparatus mounting kit comprising: a fastening and grounding system according to the first aspect of the invention and a mounting plate.

The mounting plate may have edges adapted or configured to mate with one or more holding or retainer elements by interference fit.

The mounting plate may have inclined edges so as to mate with both the one or more holding or retainer elements as well as with the at least one pushing element.

In a fourth aspect, the invention relates to a method of fastening an ozone generator apparatus according to the second aspect of the invention, the method comprising: positioning a mounting plate in surface contact with the ozone generator apparatus; rotating the at least one rotating plate element or the first rotating plate element, thereby easing at least part of the mounting plate into the one or more holding or retainer elements.

In a fifth aspect, the invention relates to a method of grounding an ozone generator apparatus according to the second aspect of the invention, the method comprising: positioning a mounting plate in surface contact with the ozone generator apparatus; rotating the at least one rotating plate element or the second rotating plate element, thereby scraping and at least removing part of an outer layer of a second surface of the mounting plate having a first surface in contact with the ozone generator apparatus and producing an earth connection between the ozone generator apparatus and the mounting plate.

In a sixth aspect, the invention relates to a method of providing heat exchange between an ozone generator apparatus according to the second aspect of the invention and a mounting plate, the method comprising: positioning a mounting plate in surface contact with the ozone generator apparatus; rotating the at least one rotating plate element, thereby establishing a tight surface contact between an external surface of the housing of the ozone generator apparatus and a surface of the mounting plate so that heat can be easily be exchanged between the metal housing and the surface of the mounting plate.

The method ensures surface contact between the housing and the mounting plate providing a better heat exchange between the two surfaces and thus improving the cooling of the ozone generator apparatus and in turn its efficiency.

The first, second, third and other aspects and embodiments of the present invention may each be combined with any of the other aspects and embodiments. These and other aspects of the invention will be apparent from and elucidated with reference to the embodiments described hereinafter.

### BRIEF DESCRIPTION OF THE FIGURES

The fastening and grounding system for fastening and providing earth connection between an ozone generator apparatus and a mounting plate, the ozone generator apparatus comprising the fastening and grounding system, the ozone generator apparatus mounting kit, the method of fastening an ozone generator apparatus, the method of grounding an ozone generator apparatus and the method of providing heat exchange between an ozone generator apparatus and a mounting plate according to the invention will now be described in more details with regard to the accompanying figures. The figures show one way of implementing the present invention and are not to be construed as being limiting to other possible embodiments falling within the scope of the attached claim set.

FIG. 1 shows a graphical illustration of the fastening and grounding system in operation on an ozone generator apparatus and a mounting plate according to some embodiments of the invention.

FIG. 2 and FIG. 3 show a graphical illustration of the fastening and grounding system according to some embodiments of the invention.

FIG. 4 shows an exploded view of the ozone generator apparatus comprising the fastening and grounding system according to some embodiments of the invention.

FIG. 5 shows a cross section of the second rotating element according to some embodiments of the invention.

FIG. 6 shows a flow-chart of a method of fastening an ozone generator apparatus according to some embodiments of the invention.

FIG. 7 shows a flow-chart of a method of grounding an ozone generator apparatus, according to some embodiments of the invention.

FIG. 8 shows a flow-chart of a method of providing heat exchange between an ozone generator apparatus and a mounting plate according to some embodiments of the invention.

### DETAILED DESCRIPTION OF AN EMBODIMENT

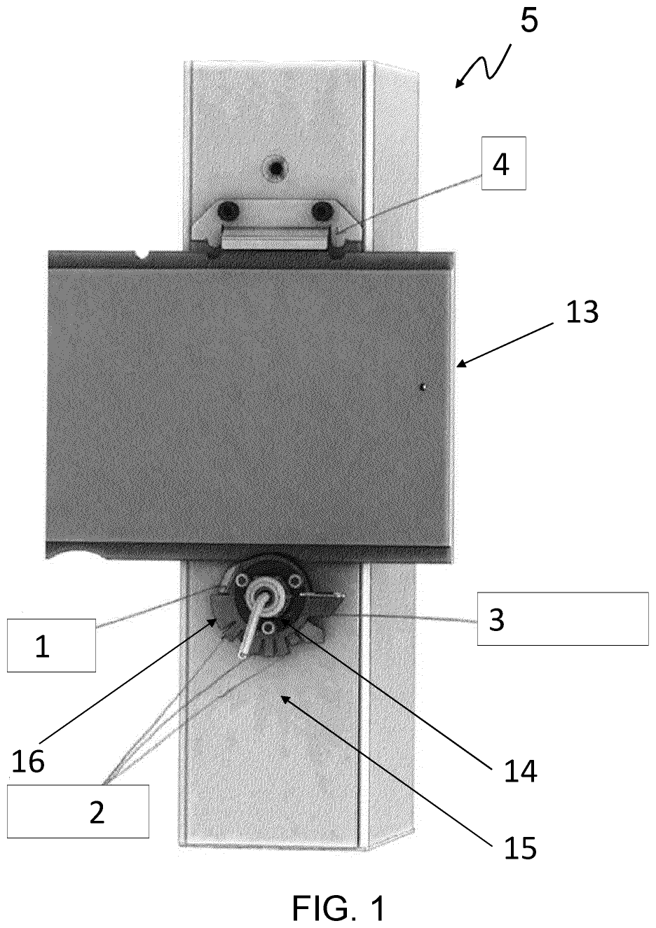

FIG. 1 shows a graphical illustration of the fastening and grounding system 14 located on the external housing 15 of an ozone generator apparatus 5.

The mounting plate 13 is pushed into bracket 4 upon rotation of the rotating ring 3 by the protrusion 1.

A portion 16 of the rotating ring 3 supports the mounting plate once the rotating ring 3 is locked according to some embodiments of the invention.

Scraping indentations 2 provide direct electrical contact upon rotation of the rotating ring 3.

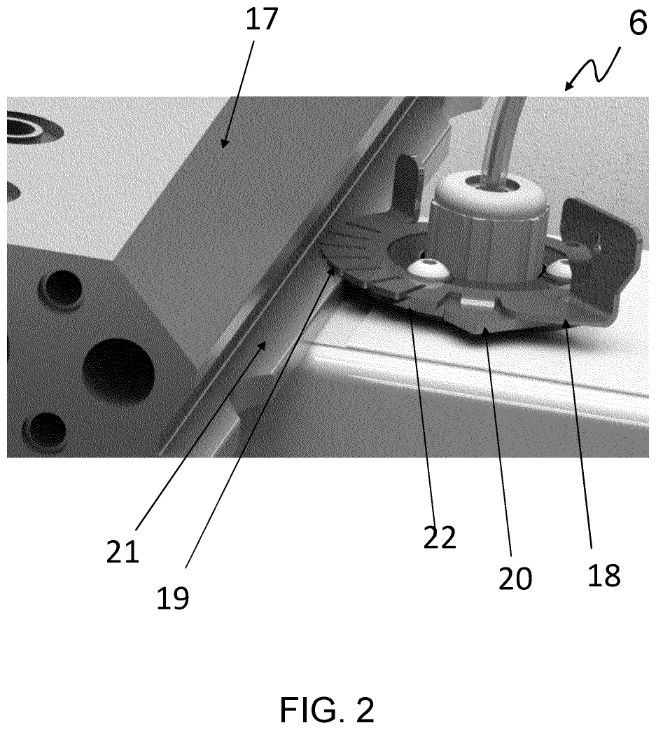

FIG. 2 shows a graphical illustration of the fastening and grounding system 6 on the housing 18 of an ozone generator apparatus.

Indentations 19 having sharp edges remove the insulating layer on the wedged edge 21 of the mounting plate 17 while ring 20 and ring 18 rotates. Protrusion 22 on ring 20 pushing mounting plate 17 in place upon rotation.

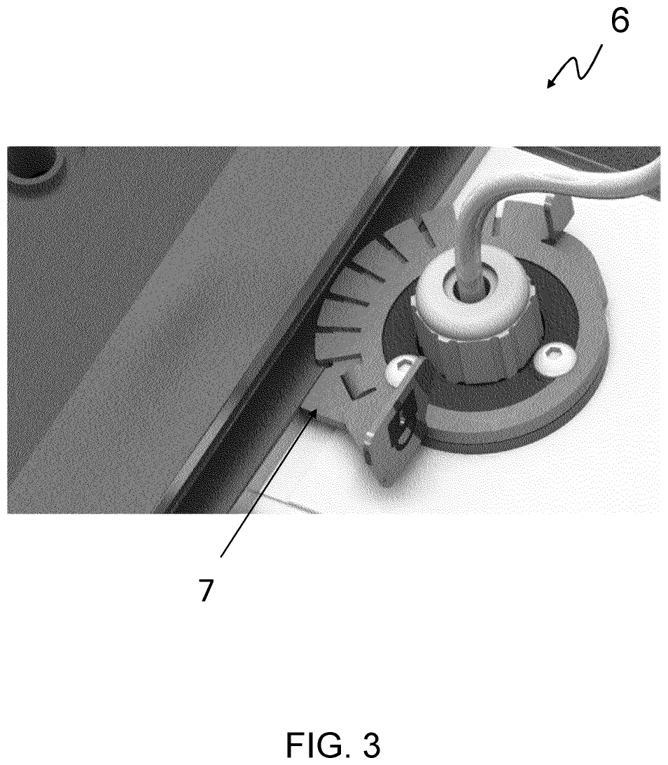

FIG. 3 shows a graphical illustration of the fastening and grounding system 6 mounting plate following rotation as in FIG. 2 from a second viewpoint.

From this viewpoint it can be seen stopping element 7 reaching the surface of the on the housing 18 of an ozone generator apparatus after rotation of rings 20 and 18.

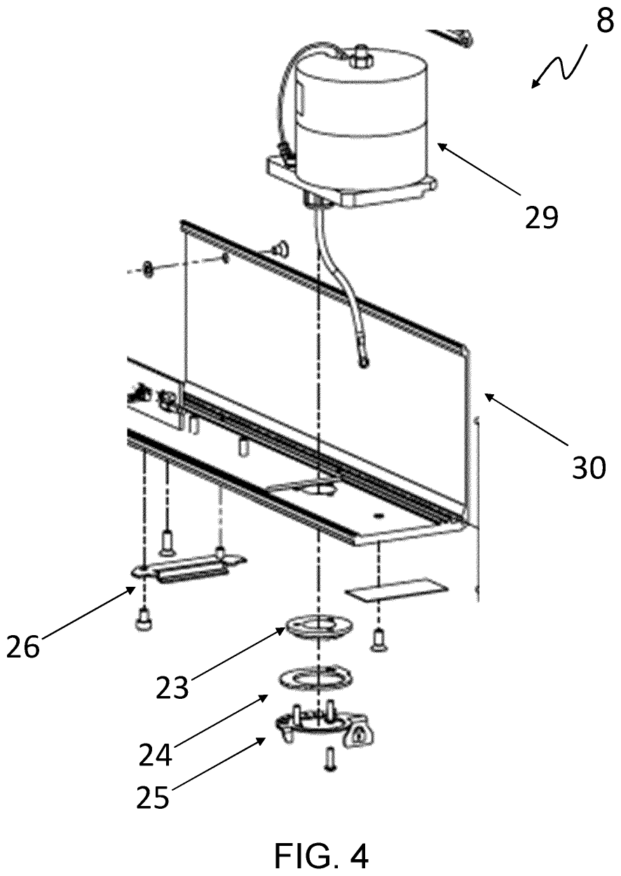

FIG. 4 shows an exploded view of the ozone generator apparatus 8 comprising the fastening and grounding system consisting of a locking sleeve 23, control sleeve 24 and a locking blade 25 and a rear bracket 26.

When mounted on a mounting plate, the power supply or high voltage transformer 29, supplying power to the ozone generator apparatus 8, is grounded upon rotation of the second rotating plate, being the locking blade 25, having indentations scraping the external surface of the mounting plate. An earth connection between the high voltage transformer 29 and the mounting plate is thus achieved.

As shown in FIG. 4, the housing 30 comprised in the ozone generator apparatus 8 is the housing of the transformer assembly or high voltage transformer 29. When mounted on a mounting plate, the housing 30 of the ozone generator apparatus 8 is fasten upon rotation of the first rotating plate, being the control sleeve 24, having a protrusion pushing the mounting plate into the rear bracket 26.

First rotating plate and second rotating plate are connected so that rotate simultaneously upon use.

FIG. 5 shows a cross section of the second rotating element, or locking blade 9 showing indentations 27 and stopping element 28.

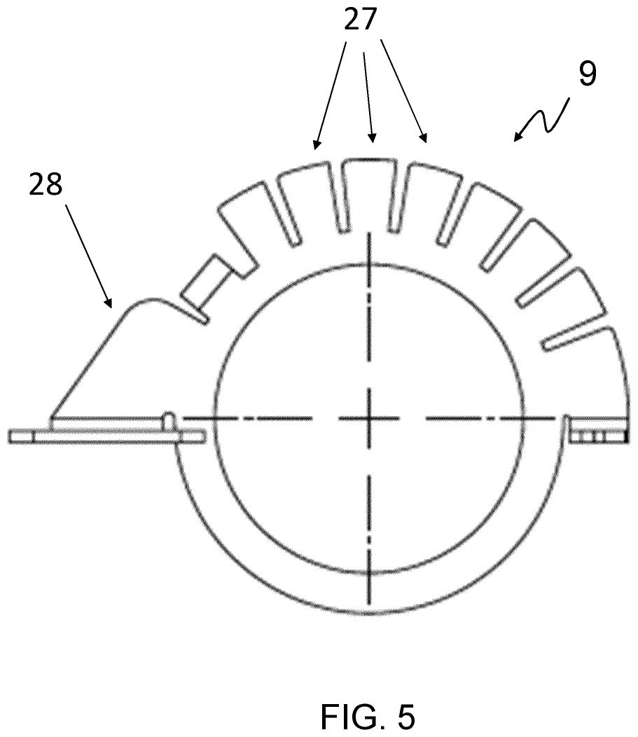

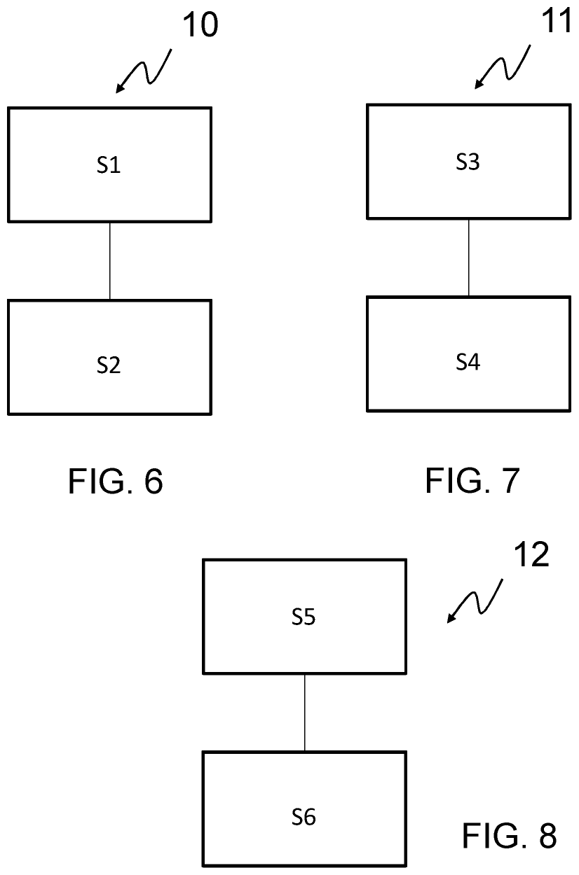

FIG. 6 shows a flow-chart of a method of fastening an ozone generator apparatus 10, according to some embodiments of the invention.

The method of fastening an ozone generator apparatus 12 comprises:
S1, positioning a mounting plate in surface contact with the ozone generator apparatus;
S2 rotating the at least one rotating plate element or the first rotating plate element, thereby easing at least part of the mounting plate into the one or more holding or retainer elements.

FIG. 7 shows a flow-chart of a method of grounding an ozone generator apparatus 11, according to some embodiments of the invention.

The method of grounding an ozone generator apparatus 11 comprises:
S3, positioning a mounting plate in surface contact with the ozone generator apparatus;
S4, rotating the at least one rotating plate element or the second rotating plate element, thereby scraping and at least removing part of an outer layer of a second surface of the mounting plate having a first surface in contact with the ozone generator apparatus and producing an earth connection between the ozone generator apparatus and the mounting plate.

FIG. 8 shows a flow-chart of a method of providing heat exchange 12 between an ozone generator apparatus and a mounting plate according to some embodiments of the invention.

The method of providing heat exchange 12 comprises:
S5 positioning a mounting plate in surface contact with the ozone generator apparatus;
S6, rotating the at least one rotating plate element, thereby establishing a tight surface contact between an external surface of the housing of the ozone generator apparatus and a surface of the mounting plate so that heat can be easily be exchanged between the metal housing and the surface of the mounting plate.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. An ozone generator apparatus comprising
a metal housing;
a fastening and grounding system configured to fasten and provide an earth connection between an ozone generator apparatus and a mounting plate, said fastening and grounding system comprising:
one or more holding or retainer elements configured to hold at least part of a mounting plate; and
at least one moveable plate element;
wherein said fastening and grounding system is located onto an external surface of said metal housing.

2-15. (canceled)

16. The ozone generator apparatus according to claim 1, wherein said at least one moveable plate element is a rotating plate element.

17. The ozone generator apparatus according to claim 16, wherein said at least one rotating plate element has at least one pushing or easing element and one or more scraping portions.

18. The ozone generator apparatus according to claim 16, wherein said at least one rotating plate element are a first rotating plate element and a second rotating plate element, wherein said first rotating plate element comprises said at least one pushing or easing element and said second rotating plate element comprises said one or more scraping portions.

19. The ozone generator apparatus according to claim 16, wherein said at least one pushing element is located at a boundary of said at least one rotating plate element or of said first rotating plate element.

20. The ozone generator apparatus according to claim 2, wherein said at least one pushing element is configured to ease, upon rotation of said at least one rotating plate element or of said first rotating plate element, at least part of a mounting plate, having a first surface in contact with said ozone generator apparatus, into said one or more holding or retainer elements.

21. The ozone generator apparatus according to claim 16, wherein said at least one pushing element comprises a bended edge portion of said boundary of said at least one rotating plate element or of said first rotating plate element.

22. The ozone generator apparatus according to claim 21, wherein said bended edge portion of said boundary of said at least one rotating plate element or of said first rotating plate element is out of plane of said at least one rotating plate element or of said first rotating plate element.

23. The ozone generator apparatus according to claim 16, wherein said one or more scraping portions are configured to, upon rotation of said at least one rotating plate element or of said second rotating plate element, scrape and at least remove part of an outer layer of a second surface of a mounting plate having a first surface in contact with said ozone generator apparatus and wherein second surface of said mounting plate is opposite to said first surface in contact with said ozone generator apparatus.

24. The ozone generator apparatus according to claim 16, wherein said one or more scraping portions comprise one or more indentations extending out of plane of said at least one rotating plate element or of said second rotating plate element, wherein said one or more indentation have sharp ends.

25. The ozone generator apparatus according to claim 16, further comprising a high voltage transformer and wherein said metal housing contains said high voltage transformer.

26. An ozone generator apparatus mounting kit comprising:
an ozone generator apparatus according to claim 1; and
a mounting plate; wherein said mounting plate has edges configured to mate with one or more holding or retainer elements by interference fit.

27. A method of fastening an ozone generator apparatus according to claim 1, said method comprising:
positioning a mounting plate in surface contact with said ozone generator apparatus; and
rotating said at least one rotating plate element or said first rotating plate element, thereby easing at least part of said mounting plate into said one or more holding or retainer elements.

28. A method of grounding an ozone generator apparatus according to claim 1, said method comprising:
positioning a mounting plate in surface contact with said ozone generator apparatus; and
rotating said at least one rotating plate element or said second rotating plate element, thereby scraping and at least removing part of an outer layer of a second surface of said mounting plate having a first surface in contact with said ozone generator apparatus and producing an earth connection between said ozone generator apparatus and said mounting plate.

29. A method of providing heat exchange between an ozone generator apparatus according to claim 1 and a mounting plate, said method comprising:
positioning a mounting plate in surface contact with said ozone generator apparatus; and
rotating said at least one rotating plate element, thereby establishing a tight surface contact between an external surface of said housing of said ozone generator apparatus and a surface of said mounting plate so that heat can be easily be exchanged between said metal housing and said surface of said mounting plate.
